(19) United States
(12) Patent Application Publication
(10) Pub. No.: US 2012/0089858 A1
(43) Pub. Date: Apr. 12, 2012

(54) CONTENT PROCESSING APPARATUS

(75) Inventors: Hideki MATSUMURA, Osaka (JP); Ichizo SAKAMOTO, Osaka (JP)

(73) Assignee: Sanyo Electric Co., Ltd., Osaka (JP)

(21) Appl. No.: 13/244,573

(22) Filed: Sep. 25, 2011

(30) Foreign Application Priority Data
Oct. 8, 2010 (JP) 2010-228087

(51) Int. Cl. G06F 1/04

(52) U.S. Cl. 713/600

(57) ABSTRACT

A content processing apparatus includes a plurality of takers. Each of a plurality of takers runs with reference to any one of N (N: an integer of two or more) of clocks, and the plurality of takers respectively take a plurality of contents. A mixer mixes the plurality of contents respectively taken by the plurality of takers so as to create equal to or less than N of output contents. A changer changes the clock referred to by each of the plurality of takers corresponding to a mode switching. An adjuster adjusts a mixing manner of the mixer in association with a change process of the changer so that a mixing process is executed for every contents corresponding to a common clock.

### CROSS REFERENCE OF RELATED APPLICATION

The disclosure of Japanese Patent Application No. 2010-228087, which was filed on Oct. 8, 2010, is incorporated here by reference.

### BACKGROUND OF THE INVENTION

1. Field of the Invention

The present invention relates to a content processing apparatus. More particularly, the present invention relates to a content processing apparatus which outputs one or at least two contents.

2. Description of the Related Art

According to one example of this type of apparatus, image data accommodation areas for a plurality of pages are respectively set to a plurality of display planes capable of being displayed in an overlapping manner. Switching the image data accommodation areas is executed for each display plane. Specifically, a display switch enable bit which indicates, for each display plane, whether or not switching the image data accommodation areas is performed is arranged in an attribute bit of a TRAP command which indicates an end of drawing one display plane. Switching the image data accommodation areas is executed to a display plane in which the display switch enable bit is equal to “1”. Thereby, without charging a load to a CPU, it becomes possible to realize to switch the image data accommodation areas, with high applicability.

However, in the above-described apparatus, a plurality of clock frequencies are not respectively allocated to the plurality of display planes, and thus, a diversity of outputted contents is limited.

### SUMMARY OF THE INVENTION

A content processing apparatus according to the present invention, comprises: a plurality of takers, each of which runs with reference to any one of N (N: an integer of two or more) of clocks, and which respectively take a plurality of contents; a mixer which mixes the plurality of contents respectively taken by the plurality of takers so as to create equal to or less than N of output contents; a changer which changes the clock referred to by each of the plurality of takers corresponding to a mode switching; and an adjuster which adjusts a mixing manner of the mixer in association with a change process of the changer so that a mixing process is executed for every contents corresponding to a common clock.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is a flowchart showing one portion of behavior of a CPU applied to the embodiment in FIG. 2;

FIG. 4 is an illustrative view showing one example of a configuration of a table referred to by the embodiment in FIG. 2;

FIG. 5 is an illustrative view showing one example of behavior of the embodiment in FIG. 2;

FIG. 6 is an illustrative view showing another example of behavior of the embodiment in FIG. 2;

FIG. 7 is an illustrative view showing still another example of behavior of the embodiment in FIG. 2; and

FIG. 8 is an illustrative view showing yet another example of behavior of the embodiment in FIG. 2.

### DETAILED DESCRIPTION OF THE PREFERRED EMBODIMENTS

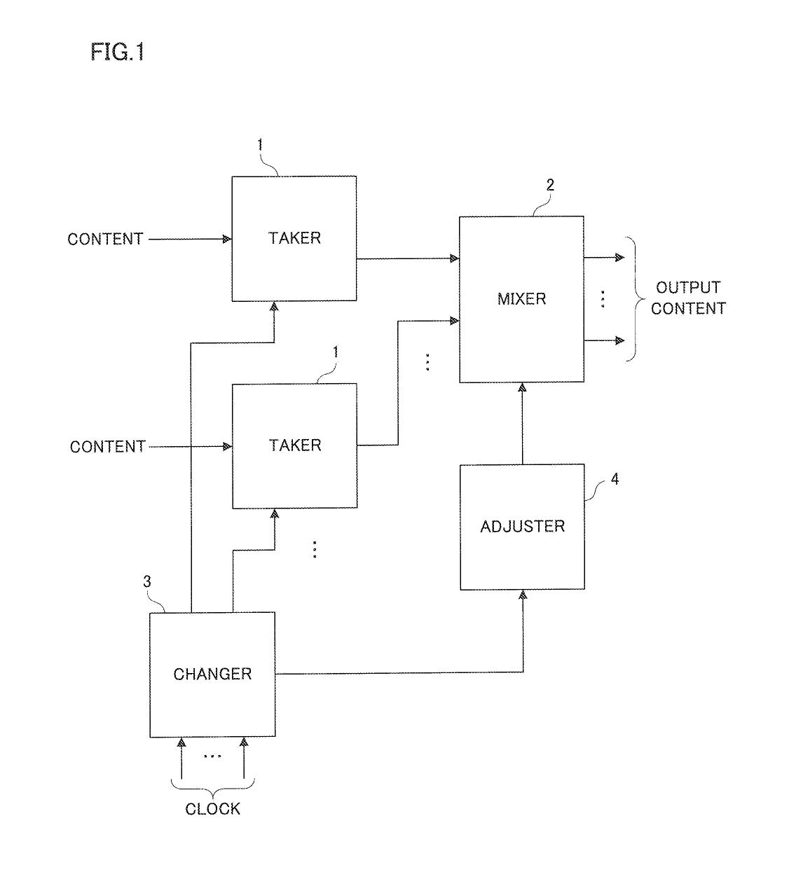

With reference to FIG. 1, a content processing apparatus according to one embodiment of the present invention is basically configured as follows: Each of a plurality of takers 1, 1, . . . runs with reference to any one of N (N: an integer of two or more) of clocks, and the plurality of takers 1, 1, . . . respectively take a plurality of contents. A mixer 2 mixes the plurality of contents respectively taken by the plurality of takers 1, 1, . . . so as to create equal to or less than N of output contents. A changer 3 changes the clock referred to by each of the plurality of takers 1, 1, . . . corresponding to a mode switching. An adjuster 4 adjusts a mixing manner of the mixer 2 in association with a change process of the changer 3 so that a mixing process is executed for every contents corresponding to a common clock.

When the mode is switched, the clock referred to by each of the plurality of takers 1, 1, . . . is changed, and furthermore, the mixing manner of the mixer 2 is adjusted so that the mixing process is executed for every contents corresponding to the common clock. Thereby, it becomes possible to improve a diversity of the outputted contents while a diversity of clock frequencies is considered.

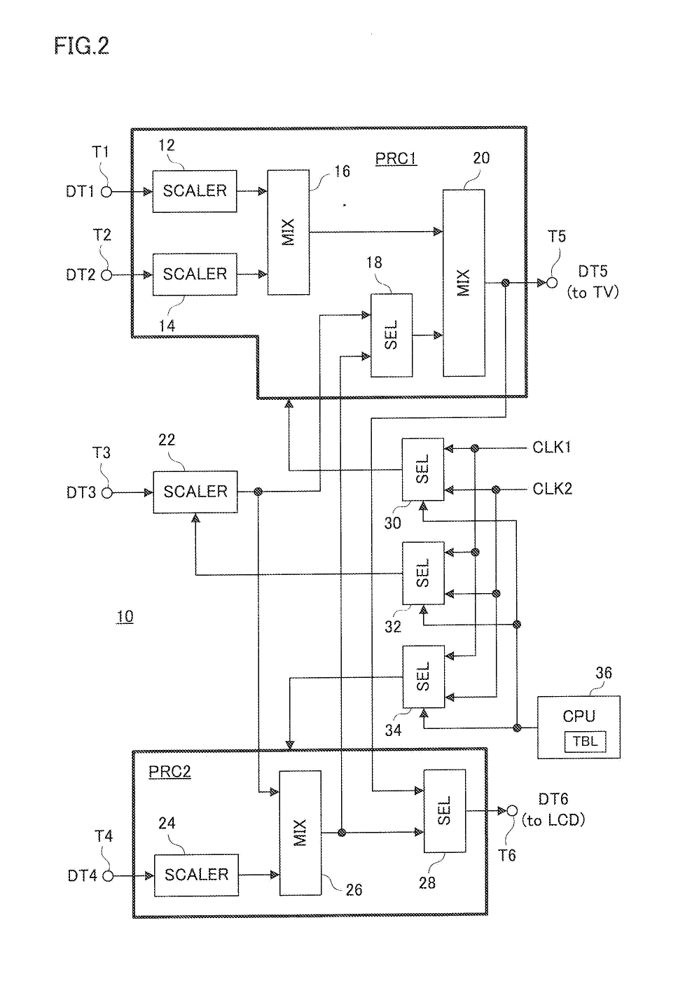

With reference to FIG. 2, a data processing apparatus 10 according to this embodiment includes terminals T1 to T4 which respectively input image data DT1 to DT4 read out from an internal memory not shown, in a parallel manner. The image data DT1 and DT2 are applied to a process circuit PRC1, the image data DT3 is applied to a scaler 22, and the image data DT4 is applied to a process circuit PRC2. It is noted that, it is possible to define a reproduced image that is based on each of the image data DT1 to DT4 as a “plane”.

Clocks CLK1 or CLK2 have mutually different frequencies and are applied to each of selectors 30 to 34. Any of the selectors 30 to 34 selects one of the clocks CLK1 and CLK2 under a control of a CPU 36. The process circuit PRC1 executes a process in synchronization with the clock applied from the selector 30, the scaler 22 executes a process in synchronization with the clock applied from the selector 32, and the process circuit PRC2 executes a process in synchronization with the clock applied from the selector 34.

A resolution of the image data DT1 is adjusted by a scaler 12 arranged in the process circuit PRC1, and a resolution of the image data DT2 is adjusted by a scaler 14 arranged in the process circuit PRC1. Moreover, a resolution of the image data DT3 is adjusted by the scaler 22, and a resolution of the image data DT4 is adjusted by a scaler 24 arranged in the process circuit PRC2.

A mixer 16 arranged in the process circuit PRC1 mixes image data outputted from the scalers 12 and 14, at a designated mixing rate. Moreover, a mixer 26 arranged in the process circuit PRC2 mixes image data outputted from the scalers 22 and 24, at the designated mixing rate.

Under the control of the CPU 36, a selector 18 arranged in the process circuit PRC1 selects one of image data outputted from the scaler 22 and the image data outputted from the mixer 26. A mixer 20 arranged in the process circuit PRC1 mixes image data outputted from the mixer 16 and the image data outputted from the selector 18, at the designated mixing rate. The mixed image data is outputted from a terminal T5 as “DT5” so as to be supplied to a TV monitor (not shown).

Under the control of the CPU 36, a selector 28 arranged in the process circuit PRC2 selects one of image data outputted from the mixer 20 and the image data outputted from the mixer 26. The selected image data is outputted from a terminal T6 as “DT6” so as to be supplied to an LCD monitor (not shown).

It is noted that, the frequency of the clock CLK1 is adapted to the TV monitor, and the frequency of the clock CLK2 is adapted to the LCD monitor.

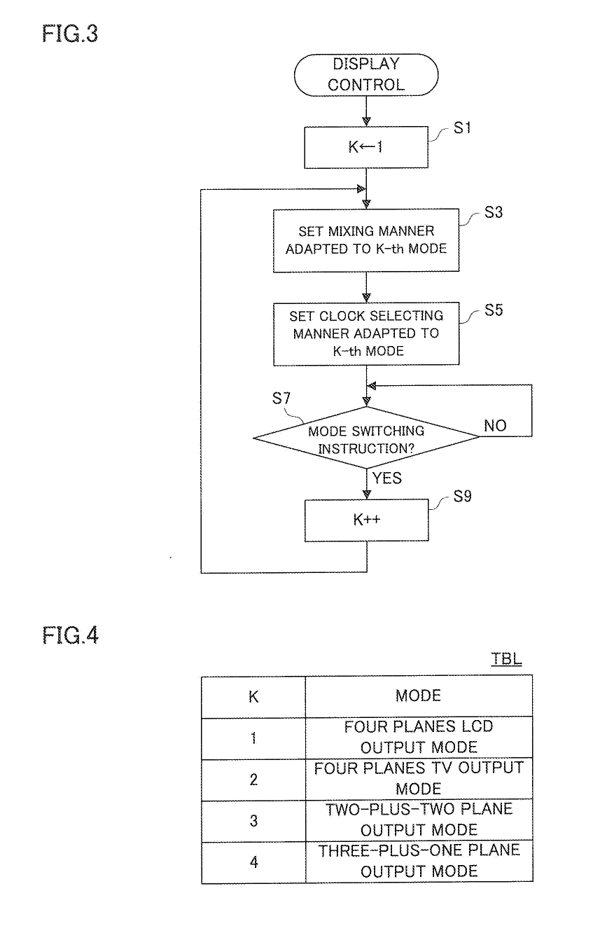

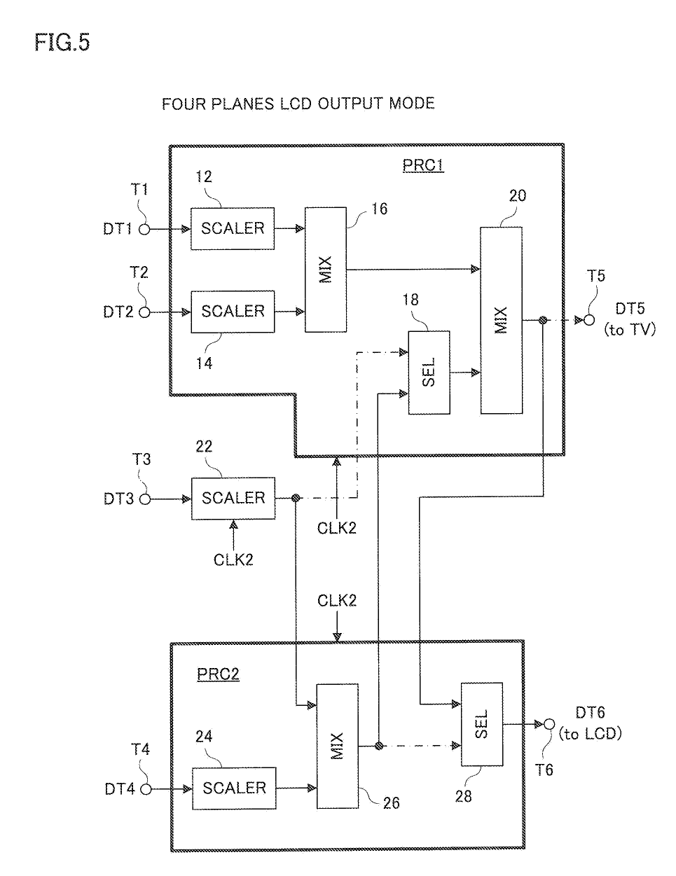

The CPU 36 executes a process according to a flowchart shown in FIG. 3 with reference to a table TBL shown in FIG. 4. Firstly, in a step S1, a variable K is set to “1”. In a step S3, a mixing manner adapted to a mode described in a K-th column of the table TBL is set to the process circuits PRC1 and PRC2. In a step S5, a clock selecting manner adapted to the mode described in the K-th column of the table TBL is set to the selectors 30 to 34. In a step S7, it is determined whether or not a mode switching instruction is issued. When a determined result is updated from NO to YES, in a step S9, the variable K is incremented. The variable K is updated in circulation among “1” and “4”. Upon completion of the process in the step S9, the process returns to the step S3.

According to FIG. 4, in a first column of the table TBL, a mixing manner and a clock selecting manner corresponding to a four planes LCD output mode are described. In a second column of the table TBL, a mixing manner and a clock selecting manner corresponding to a four planes TV output mode are described. In a third column of the table TBL, a mixing manner and a clock selecting manner corresponding to a two-plus-two plane output mode are described. In a fourth column of the table TBL, a mixing manner and a clock selecting manner corresponding to a three-plus-one plane output mode are described.

It is noted that the four planes LCD output mode is a mode in which four reproduced images based on the image data DT1 to DT4 are displayed on the LCD monitor. The four planes TV output mode is a mode in which the four reproduced images based on the image data DT1 to DT4 are displayed on the TV monitor.

The two-plus-two plane output mode is a mode in which two reproduced images based on the image data DT1 and DT2 are displayed on the TV monitor and two reproduced images based on the image data DT3 and DT4 are displayed on the LCD monitor. The three-plus-one plane output mode is a mode in which three reproduced images based on the image data DT1 and DT3 are displayed on the TV monitor and one reproduced image based on the image data DT4 is displayed on the LCD monitor.

With reference to FIG. 5, in the four planes LCD output mode, each of the mixers 16, 20 and 26 mixes the image data at a mixing rate of 50 to 50, the selector 18 selects output of the mixer 26, and the selector 28 selects output of the mixer 20. Moreover, any of the selectors 30 to 34 selects the clock CLK2. Furthermore, the TV monitor is disconnected to the terminal T5 or becomes an off-state. As a result, the image data created by mixing the image data DT1 to DT4 is outputted from the terminal T6 as the “DT6”.

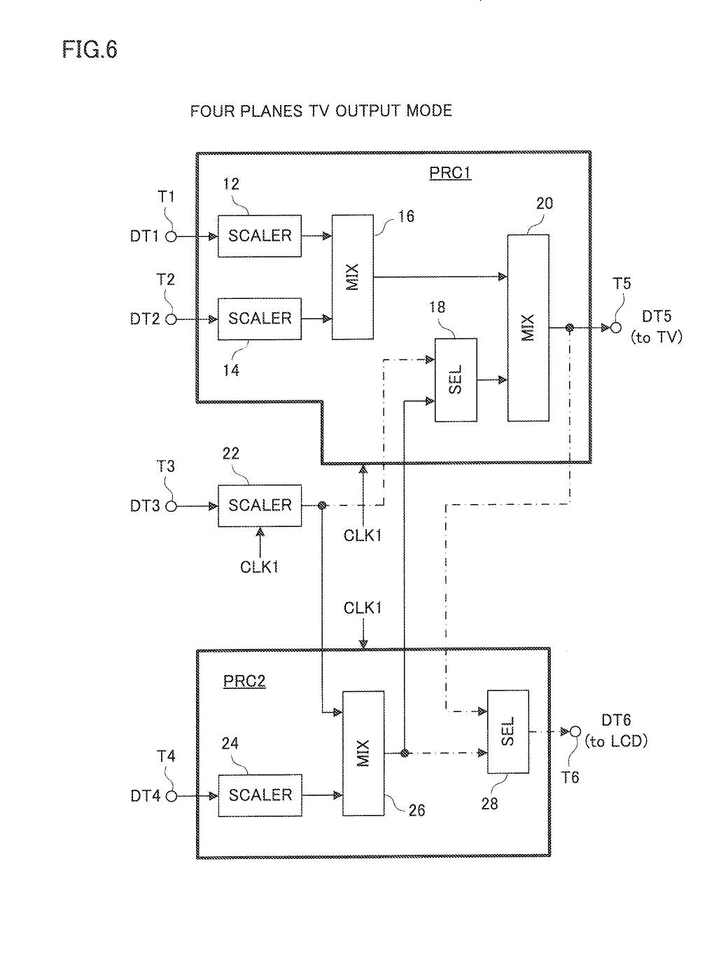

With reference to FIG. 6, in the four planes TV output mode, each of the mixers 16, 20 and 26 mixes the image data at the mixing rate of 50 to 50, and the selector 18 selects the output of the mixer 26. Moreover, any of the selectors 30 to 34 selects the clock CLK1. Furthermore, the LCD monitor is disconnected to the terminal T6 or becomes the off-state. As a result, the image data created by mixing the image data DT1 to DT4 is outputted from the terminal T5 as the “DT5”.

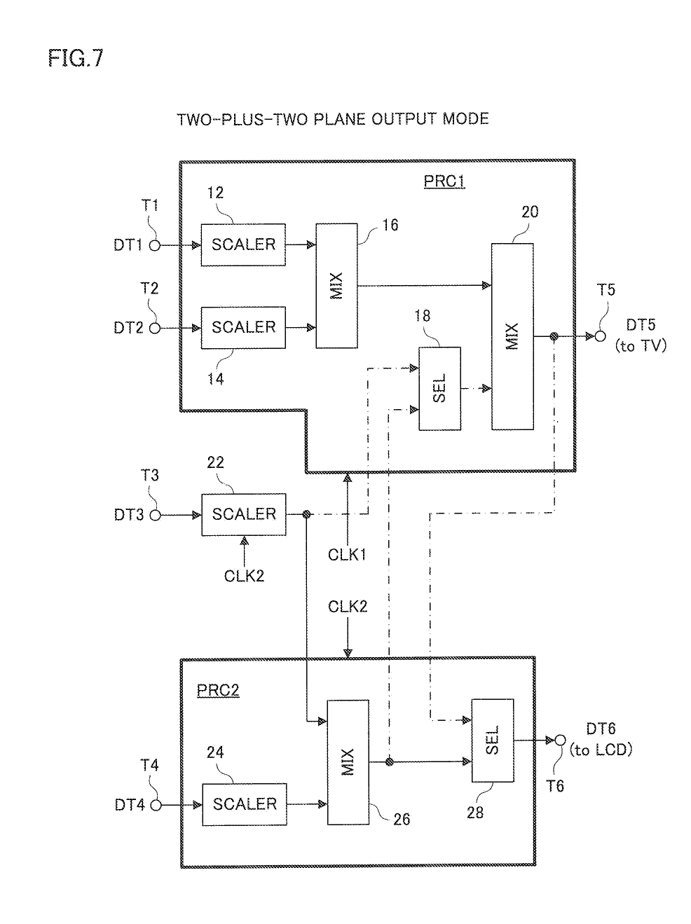

With reference to FIG. 7, in the two-plus-two plane output mode, each of the mixers 16 and 26 mixes the image data at the mixing rate of 50 to 50, the mixer 20 mixes the image data at a mixing rate of 100 to 0 (a ratio of output of the mixer 16 is 100), and the selector 28 selects the output of the mixer 26. Moreover, the selector 30 selects the clock CLK1, and each of the selectors 32 and 34 selects the clock CLK2. As a result, the image data created by mixing the image data DT1 and DT2 is outputted from the terminal T5 as the “DT5”, and the image data created by mixing the image data DT3 and DT4 is outputted from the terminal T6 as the “DT6”.

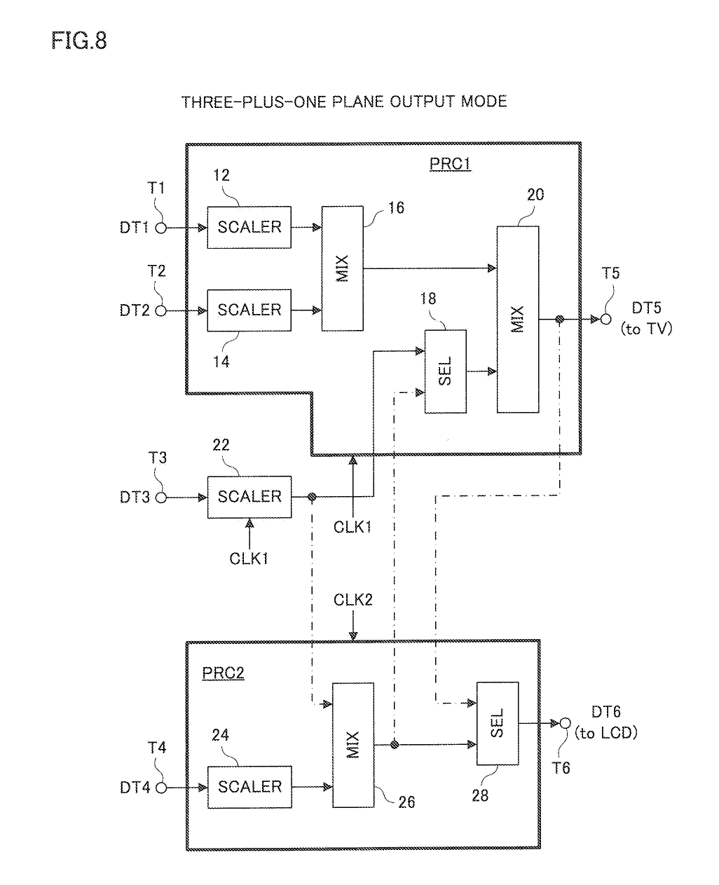

With reference to FIG. 8, in the three-plus-one plane output mode, each of the mixers 16 and 20 mixes the image data at the mixing rate of 50 to 50, the mixer 26 mixes the image data at the mixing rate of 100 to 0 (a ratio of output of the scaler 24 is 100), the selector 18 selects output of the scaler 22, and the selector 28 selects the output of the mixer 26. Moreover, each of the selectors 30 and 32 selects the clock CLK1, and the selector 34 selects the clock CLK2. As a result, the image data created by mixing the image data DT1 to DT3 is outputted from the terminal T5 as the “DT5”, and the image data DT4 is outputted from the terminal T6 as the “DT6”.

As can be seen from the above described explanation, the image data DT1 and DT2 are respectively taken by the scalers 12 and 14 arranged in the process circuit PRC1. Moreover, the image data DT3 is taken by the scaler 22, and the image data DT4 is taken by the scaler 24 arranged in the process circuit PRC2. The selector 30 applies the clock CLK1 or CLK2 to the process circuit PRC1, the selector 32 applies the clock CLK1 or CLK2 to the scaler 22, and the selector 34 applies the clock CLK1 or CLK2 to the process circuit PRC2. The mixers 16, 20 and the selector 18 arranged in the process circuit PRC1 and the mixer 26 and the selector 28 arranged in the process circuit PRC2 create the image data DT5 and/or DT6 by mixing the image data outputted from the scalers 12, 14, 22 and 24. The CPU 36 adjusts the selecting manner of the selectors 30 to 34 so as to be different depending on the mode (S5), and also adjusts the mixing manner of the image data so that the mixing process is executed for every image data corresponding to the common clock (S3).

Thus, when the mode is changed, the clock selecting manner by the selectors 30 to 34 is adjusted, and furthermore, the mixing manner is adjusted so that the mixing process is executed for every image data corresponding to the common clock. Thereby, it becomes possible to improve a diversity of the image data DT5 and/or DT6 while the diversity of clock frequencies is considered.

It is noted that, in this embodiment, the image data is assumed as a content of a process-target, however, instead of the image data or together with the image data, the sound data may be processed. Moreover, it is possible to apply the data processing apparatus according to this embodiment to a display system of a digital camera. At this time, the LCD monitor described above is equivalent to a monitor installed in the digital camera

Although the present invention has been described and illustrated in detail, it is clearly understood that the same is by way of illustration and example only and is not to be taken by way of limitation, the spirit and scope of the present invention being limited only by the terms of the appended claims.

What is claimed is

1. A content processing apparatus, comprising:
a plurality of takers, each of which runs with reference to any one of N (N: an integer of two or more) of clocks, and which respectively take a plurality of contents;
a mixer which mixes the plurality of contents respectively taken by said plurality of takers so as to create equal to or less than N of output contents;
a changer which changes the clock referred to by each of the plurality of takers corresponding to a mode switching; and
an adjuster which adjusts a mixing manner of said mixer in association with a change process of said changer so that a mixing process is executed for every contents corresponding to a common clock.

2. A content processing apparatus according to claim 1, wherein said mixer includes N of content outputters respectively corresponding to N of output devices.

3. A content processing apparatus according to claim 1, wherein any of the plurality of contents respectively taken by said plurality of takers is equivalent to image data.

4. A content processing apparatus according to claim 3, wherein each of said plurality of takers adjusts a resolution in response to a reference clock.
